(19) United States
(12) Patent Application Publication
(10) Pub. No.: US 2016/0138448 A1
(43) Pub. Date: May 19, 2016

(54) EXHAUST GAS PURIFICATION FILTER

(71) Applicant: TOYOTA JIDOSHA KABUSHIKI KAISHA, Toyota-shi, Aichi-ken (JP)

(72) Inventors: Kazuhiro ITOH, Mishima-shi, Shizuoka-ken (JP); Hiromasa NISHIOKA, Susono-shi, Shizuoka-ken (JP); Daichi IMAI, Suntou-gun, Shizuoka-ken (JP); Yoshihisa TSUKAMOTO, Susono-shi, Shizuoka-ken (JP); Hiroshi OTSUKI, Gotenba-shi, Shizuoka-ken (JP); Yasumasa NOTAKE, Susono-shi, Shizuoka-ken (JP)

(73) Assignee: TOYOTA JIDOSHA KABUSHIKI KAISHA, Toyota-shi, Aichi-ken (JP)

(21) Appl. No.: 14/896,725

(22) PCT Filed: Jun. 3, 2014
(86) PCT No.: PCT/IB2014/000941

§ 371 Date: Dec. 8, 2015

(30) Foreign Application Priority Data
Jun. 10, 2013 (JP) 2013-121850

(51) Int. Cl. F01N 3/035; B01D 53/94; F01N 3/022

(52) U.S. Cl. CPC F01N 3/035; F01N 3/0222; B01D 53/94

(57) ABSTRACT

An exhaust gas purification filter includes an inflow/outflow passage through which exhaust gas flows in/out, and a partition. The outflow passage and the inflow passage is alternately arranged. The partition is configured to divide the inflow passage and the outflow passage from each other, and being porous. The partition includes a coated zone where a surface of a base of the partition is covered with a first coating layer having an average pore diameter smaller than an average pore diameter of the base, and a non-coated zone where the surface of the base is not covered with the first coating layer on a downstream side of the coated zone. The average pore diameter of the base is large enough for ash to pass through the partition, and the first coating layer is constituted by a plurality of particle groups with different average particle diameters from each other.

### BACKGROUND OF THE INVENTION

1. Field of the Invention

The present invention relates to an exhaust gas purification filter.

2. Description of Related Art

In a compression-ignition internal combustion engine in which a particulate filter that collects particulate matter in exhaust gas is arranged within an exhaust passage, the particulate filter includes exhaust-gas inflow passages and exhaust-gas outflow passages that are alternately arranged, and a porous partition that divides these exhaust-gas inflow passages and exhaust-gas outflow passages from each other. In this particulate filter, the exhaust-gas inflow passage is closed at its downstream end by a downstream-side plug, and the exhaust-gas outflow passage is closed at its upstream end by an upstream-side plug. Therefore, exhaust gas first flows into the exhaust-gas inflow passage, then passes through the peripheral partition, and flows out into the adjacent exhaust-gas outflow passage. As a result, particulate matter in the exhaust gas is collected on the partition, and is thus suppressed from being released in the atmosphere.

As the amount of particulate matter collected on the particulate filter increases, the pressure loss increases gradually in the particulate filter. Consequently, the engine output may be decreased. Thus, in this internal combustion engine, the PM removing process, in which the temperature of the particulate filter is increased, while maintaining the particulate filter in an oxidizing atmosphere, is performed to burn and remove the particulate matter from the particulate filter.

A non-combustible component, referred to as “ash,” is included in exhaust gas. The ash is collected along with the particulate matter by the particulate filter. Even though the PM removing process is performed, the ash is not burned or vaporized, but remains on the particulate filter. Thus, as the engine operating time becomes longer, the amount of ash collected on the particulate filter increases gradually, and accordingly the pressure loss increases gradually in the particulate filter. Consequently, even when the PM removing process is repeatedly performed, the engine output may be decreased.

Japanese Patent Application Publication No. 2004-130229 (JP 2004-130229 A) discloses a particulate filter in which a through hole is formed in a downstream-side plug so as to flow ash out of the particulate filter through the through hole. In JP 2004-130229 A, as the engine operating time becomes longer, the through hole is closed by particulate matter. When the through hole is closed, the particulate filter can collect particulate matter in the same manner as a conventional particulate filter that does not include any through hole. Next, the PM removing process is performed, and then the particulate matter having closed the through hole is removed and thus the through hole is opened. As a result, ash on the particulate filter is discharged from the particulate filter through the through hole.

### SUMMARY OF THE INVENTION

In JP 2004-130229 A, there is a possibility of particulate matter flowing out of the particulate filter through the through hole during a period from when the engine operation is started or when the PM removing process is finished to when the through hole is closed. In JP 2004-130229 A, because the diameter of the through hole is set equal to or larger than 0.2 mm, a considerable amount of time may be required for the through hole with a diameter of this size to be closed by particulate matter. Thus, there is a possibility of an increase in the amount of particulate matter that flows out of the particulate filter through the through hole.

The present invention provides an exhaust gas purification filter that can suppress an increase in pressure loss in the exhaust gas purification filter caused by ash, while reliably collecting particulate matter.

According to an aspect of the present invention, an exhaust gas purification filter that is arranged within an exhaust passage of an internal combustion engine, and that collects particulate matter included in exhaust gas. The exhaust gas purification filter includes an inflow passage through which exhaust gas flows in, an outflow passage through which exhaust gas flows out, the outflow passage and the inflow passage being alternately arranged, and a partition. The partition is configured to divide the inflow passage and the outflow passage from each other, and being porous. The partition includes a coated zone where a surface of a base of the partition is covered with a first coating layer having an average pore diameter smaller than an average pore diameter of the base, and a non-coated zone where the surface of the base is not covered with the first coating layer on a downstream side of the coated zone. The average pore diameter of the base in the non-coated zone is large enough for ash included in exhaust gas to pass through the partition, and the first coating layer is constituted by a plurality of particle groups with different average particle diameters from each other.

In the above exhaust gas purification filter, the plurality of particle groups may be arranged substantially into layers on the base, and an average particle diameter of the particle group that forms a layer closer to the base may be larger than an average particle diameter of the particle group that forms a layer farther away from the base.

In the above exhaust gas purification filter, the plurality of particle groups may be arranged on the base in an almost evenly mixed state.

In the above exhaust gas purification filter, the particle groups that form the first coating layer may be made from metal having a catalytic function.

In the above exhaust gas purification filter, a second coating layer that is different from the first coating layer may be provided in the non-coated zone, and the second layer may include a catalyst.

In the above exhaust gas purification filter, the inflow passage may be opened at an exhaust-gas upstream end, and be closed at an exhaust-gas downstream end, and the outflow passage may be closed at the upstream end, and be opened at the downstream end.

With the above configuration, an increase in pressure loss in the exhaust gas purification filter caused by ash can be suppressed, while reliably collecting particulate matter.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is an overall view of an internal combustion engine according to an embodiment of the present invention;

FIG. 2A is a front view of a particulate filter according to the embodiment;

FIG. 2B is a side cross-sectional view of the particulate filter according to the embodiment;

FIG. 3 is a partially-enlarged cross-sectional view of a partition according to the embodiment;

FIG. 4 is a partially-enlarged view of a coating layer according to the embodiment;

FIG. 5 is a graph showing the size distribution of particles that form the coating layer according to the embodiment;

FIG. 6 is a partially-enlarged cross-sectional view of the coating layer according to the embodiment;

FIG. 7A is a partially-enlarged cross-sectional view of a coating layer according to another embodiment of the present invention;

FIG. 7B is a partially-enlarged cross-sectional view of a coating layer according to yet another embodiment of the present invention;

FIG. 7C is a partially-enlarged cross-sectional view of a coating layer according to yet another embodiment of the present invention;

FIG. 7D is a partially-enlarged cross-sectional view of a coating layer according to yet another embodiment of the present invention;

FIG. 8 is a schematic view for explaining an operation of the particulate filter according to the embodiment;

FIG. 9A is an explanatory view of a gap between particles;

FIG. 9B is an explanatory view of the gap between the particles;

FIG. 9C is an explanatory view of the gap between the particles; and

FIG. 10 is a partially-enlarged cross-sectional view of a partition according to another embodiment of the present invention.

### DETAILED DESCRIPTION OF EMBODIMENTS

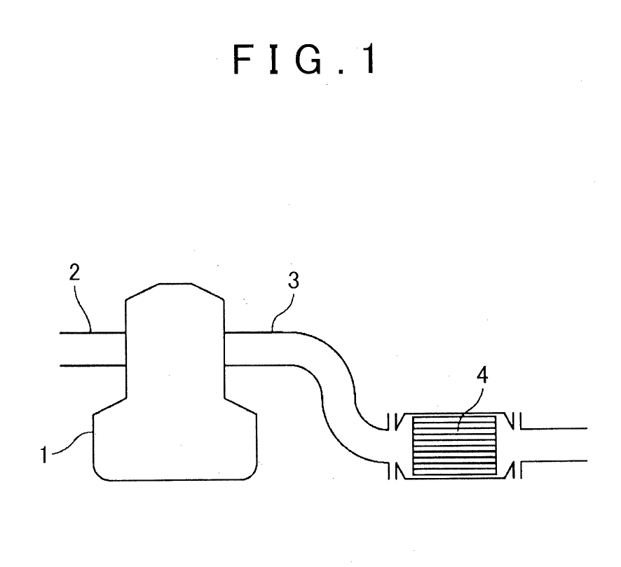

With reference to FIG. 1, a reference numeral 1 denotes a main unit of an internal combustion engine, a reference numeral 2 denotes an intake passage, a reference numeral 3 denotes an exhaust passage, and a reference numeral 4 denotes an exhaust gas purification filter that is arranged within the exhaust passage 3. In an embodiment shown in FIG. 1, the exhaust gas purification filter 4 is constituted by a wall-flow particulate filter. In the embodiment shown in FIG. 1, the internal combustion engine 1 is constituted by a compression-ignition internal combustion engine. However, the internal combustion engine 1 is not limited to the internal combustion engine in the present embodiment, and is constituted by a spark-ignition internal combustion engine in another embodiment.

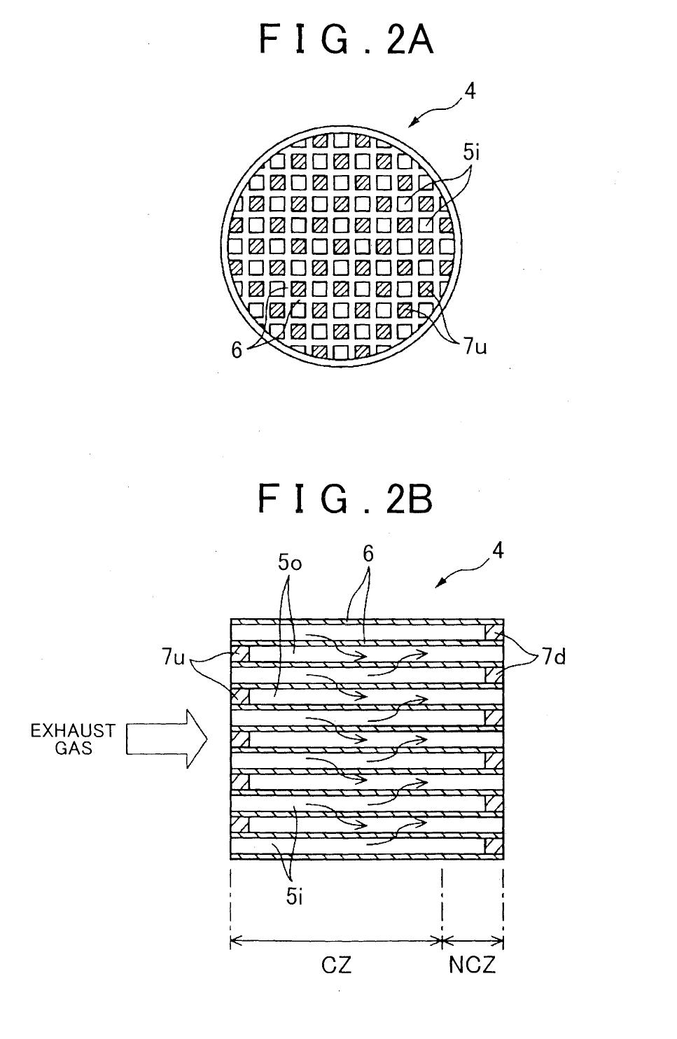

FIGS. 2A and 2B show the structure of the particulate filter 4. FIG. 2A is a front view of the particulate filter 4. FIG. 2B is a side cross-sectional view of the particulate filter 4. As shown in FIGS. 2A and 2B, the particulate filter 4 has a honeycomb structure, and includes a plurality of exhaust flow passages 5i and 5o that extend parallel to each other, and a partition 6 that divides the exhaust flow passages 5i and 5o from each other. In the embodiment shown in FIGS. 2A and 2B, the exhaust flow passages 5i and 5o are constituted by an exhaust-gas inflow passage 5i with its upstream end opened and with its downstream end closed by a plug 7d, and an exhaust-gas outflow passage 5o with its upstream end closed by a plug 7u and with its downstream end opened. In FIG. 2A, the hatching portion shows the plug 7u. The exhaust-gas inflow passages 5i and the exhaust-gas outflow passages 5o are alternately arranged with the partition 6, which is a thin wall, interposed therebetween. In other words, the exhaust-gas inflow passages 5i and the exhaust-gas outflow passages 5o are arranged such that each of the exhaust-gas inflow passages 5i is surrounded by four exhaust-gas outflow passages 5o, and each of the exhaust-gas outflow passages 5o is surrounded by four exhaust-gas inflow passages 5i. However, the present invention is not limited to this configuration, and in another embodiment, exhaust flow passages are constituted by an exhaust-gas inflow passage with its upstream end and downstream end opened, and an exhaust-gas outflow passage with its upstream end closed by a plug and with its downstream end opened.

In yet another embodiment, the partition 6 around the downstream end of the exhaust-gas inflow passage 5i is deformed to close this downstream end, and the partition 6 around the upstream end of the exhaust-gas outflow passage 5o is deformed to close this upstream end. This makes the plugs 7u and 7d unnecessary.

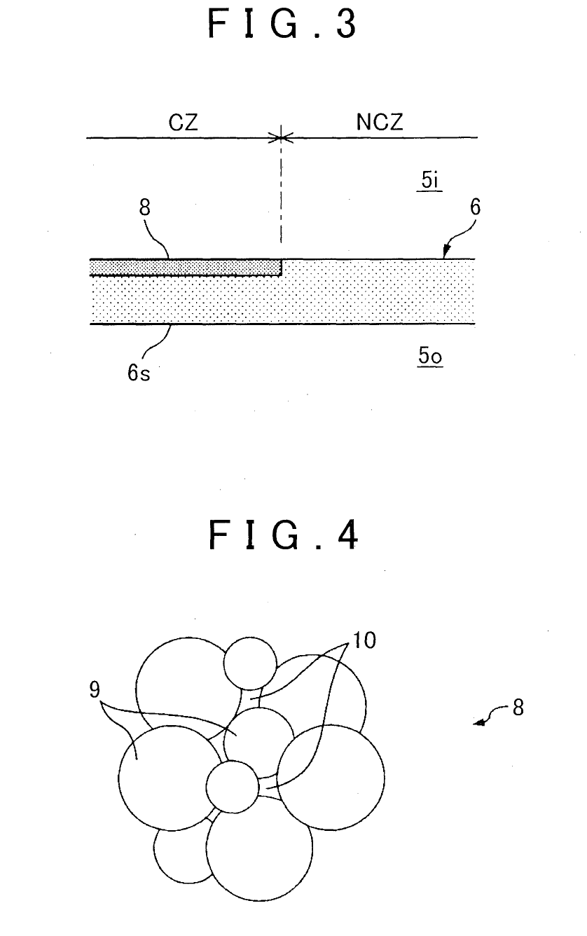

As shown in FIG. 2B, the partition 6 is divided into a coated zone CZ and a non-coated zone NCZ that is positioned on the downstream side of the coated zone CZ. As shown in FIG. 3, in the coated zone CZ, the surface of a base 6s of the partition 6 is covered with a coating layer 8. In contrast to this, in the non-coated zone NCZ, the surface of the partition base 6s is not covered with the coating layer 8 described above.

In the embodiment shown in FIG. 3, the coating layer 8 is provided on one surface of the partition base 6s, which faces the exhaust-gas inflow passage 5i. In another embodiment, the coating layer 8 is provided on one surface of the partition base 6s, which faces the exhaust-gas outflow passage 5o. In yet another embodiment, the coating layer 8 is provided on both surfaces of the partition base 6s, which face the exhaust-gas inflow passage 5i and the exhaust-gas outflow passage 5o, respectively. A part of the coating layer 8 may sometimes reach a part or all of the inner surfaces of the partition 6 at the pore.

In the embodiment shown in FIG. 2B, the upstream edge of the coated zone CZ substantially corresponds with the upstream end of the partition 6. In the embodiment shown in FIG. 2B, the downstream edge of the non-coated zone NCZ substantially corresponds with the downstream end of the partition 6. However, the positioning of the coated zone CZ and the non-coated zone NCZ is not limited to that described in the present embodiment. In another embodiment, the upstream edge of the coated zone CZ is positioned on the downstream side of the upstream end of the partition 6. In yet another embodiment, the downstream edge of the non-coated zone NCZ is positioned on the upstream side of the downstream end of the partition 6. The longitudinal length of the coated zone CZ is set to 50% to 90% of the longitudinal length of the particulate filter 4, for example.

The partition base 6s is formed from a porous material that is, for example, ceramics such as cordierite, silicon carbide, silicon nitride, zirconia, titania, alumina, silica, mullite, lithium aluminum silicate, or zirconium phosphate.

As shown in FIG. 4, the coating layer 8 is formed from multiple particles 9, and includes multiple gaps or pores 10 between the particles 9. Thus, the coating layer 8 is porous. Therefore, as shown by the arrows in FIG. 2B, exhaust gas first flows into the exhaust-gas inflow passage 5i, then passes through the partition 6 around the exhaust-gas inflow passage 5i, and flows out into the exhaust-gas outflow passage 5o adjacent to the exhaust-gas inflow passage 5i.

In the embodiment shown in FIG. 4, the particles 9 are made from metal having a catalytic function. Examples of the catalytic function include an oxidizing function and an NOx reduction action in the presence of a reductant such as HC or ammonia. Platinum-group metal such as platinum (Pt), rhodium (Rh), or palladium (Pd) or metal such as copper (Cu), iron (Fe), silver (Ag), or cesium (Cs) can be used as the metal having the oxidizing function. In another embodiment, the particles 9 are made from ceramics that are the same as those used for the partition base 6s, or from oxides such as Y—Pr—Ce oxides, CeO₂, or SiO₂, as the metal having the oxidizing function. In yet another embodiment, the particles 9 are made from the above metal and ceramics or from the above metal and oxides.

The average pore diameter of the partition base 6s is equal to or larger than 25 μm and equal to or smaller than 100 μm in the present embodiment. When the average pore diameter of the partition base 6s is equal to or larger than 25 μm, most of the ash included in exhaust gas can pass through the partition 6. In other words, the pore diameter of the partition 6 is set such that ash included in exhaust gas can pass through the partition 6 in the non-coated zone NCZ. In yet another description, the pore diameter of the partition 6 is set such that the rate of ash collected in the non-coated zone NCZ is lower than the allowable rate. This allowable rate is 50%, for example. Assuming that the average particle diameter of particulate matter is smaller than the average particle diameter of ash, it can also be considered that the pore diameter of the partition 6 is set such that particulate matter and ash can pass through the partition 6 in the non-coated zone NCZ.

The average pore diameter of the coating layer 8 is set smaller than the average pore diameter of the partition base 6s. Specifically, the average pore diameter of the coating layer 8 is set such that the coating layer 8 can collect particulate matter included in exhaust gas.

In the present embodiment, the average diameter of pores in a partition base refers to the median diameter (50% diameter) of the pore diameter distribution obtained by the mercury penetration method, and the average diameter of particles refers to the median diameter (50% diameter) of the volume-based particle-size distribution obtained by the laser diffraction/scattering method.

In the embodiment shown in FIG. 4, the coating layer 8 is formed from a small-diameter particle group with a small average particle diameter and a large-diameter particle group with a large average particle diameter. In other words, as shown in FIG. 5, two different peaks appear in the size distribution of particles that form the coating layer 8. In FIG. 5, PS represents the small-diameter particle group, and PL represents the large-diameter particle group.

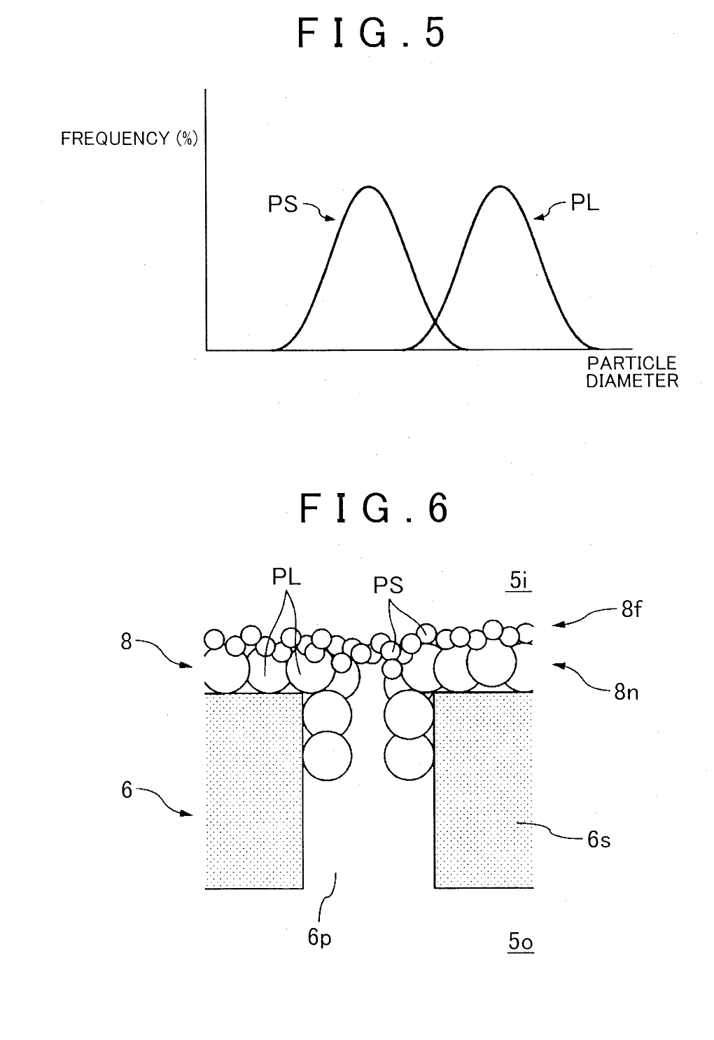

FIG. 6 illustrates an example of the coating layer 8. In the example shown in FIG. 6, the small-diameter particle group PS and the large-diameter particle group PL that form the coating layer 8 are arranged substantially into layers on the partition base 6s. That is, the coating layer 8 includes a layer 8n that is closer to the partition base 6s, and a layer 8f that is farther away from the partition base 6s. In other words, in the example in FIG. 6, the layer 8n covers the surface of the partition base 6s, and further the layer 8f covers the layer 8n. That is, the coating layer 8 is formed with the layer 8n and the layer 8f overlapping substantially into layers. The layer 8n that is closer to the partition base 6s is formed mainly from the large-diameter particle group PL. The layer 8f that is farther away from the partition base 6s is formed mainly from the small-diameter particle group PS. In other words, the average particle diameter of the particle group that forms the layer 8n that is closer to the partition base 6s is larger than the average particle diameter of the particle group that forms the layer 8f that is farther away from the partition base 6s. There is a case where some particles of the large-diameter particle group PL can be present within the layer 8f, and some particles of the small-diameter particle group PS can be present within the layer 8n.

In the example shown in FIG. 6, slurry including the large-diameter particle group PL is applied to the partition base 6s, thereby forming the layer 8n on the partition base 6s. Next, slurry including the small-diameter particle group PS is applied to the partition base 6s, thereby forming the layer 8f on the layer 8n. As a result, the coating layer 8 is formed into layers.

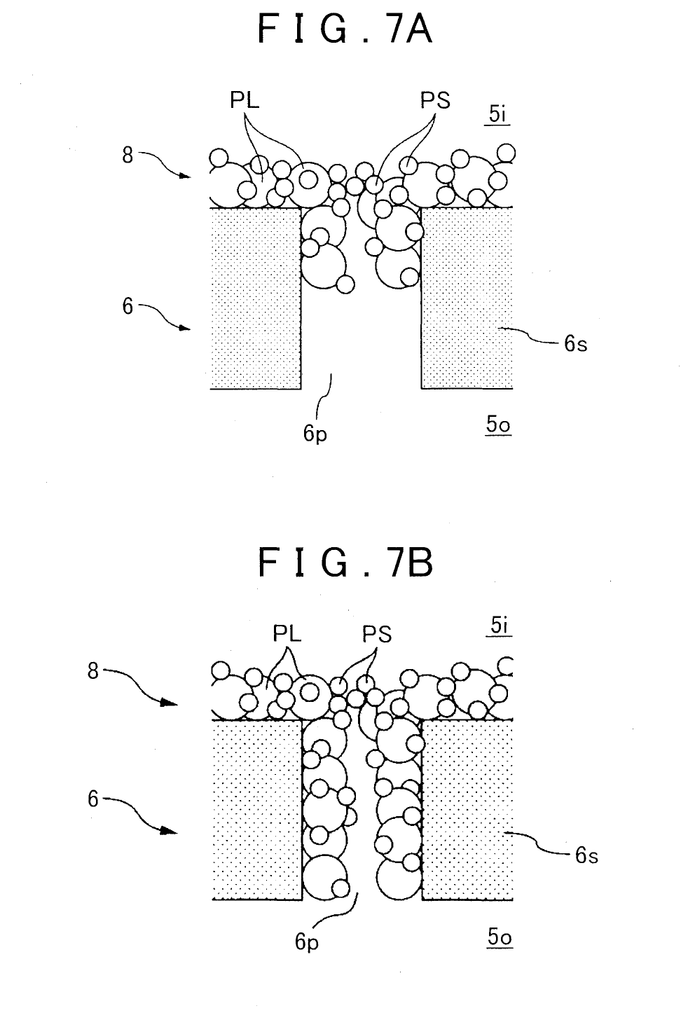

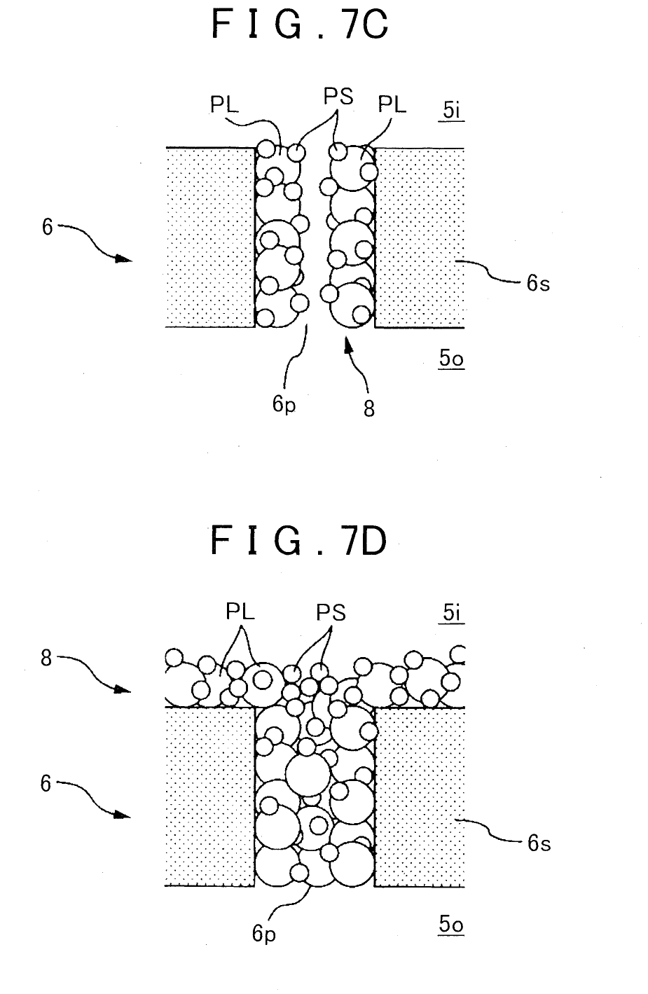

FIGS. 7A to 7D illustrate other examples of the coating layer 8. In the examples shown in FIGS. 7A to 7D, the small-diameter particle group PS and the large-diameter particle group PL that form the coating layer 8 are arranged on the partition base 6s in an almost evenly mixed state.

In the examples shown in FIGS. 7A to 7D, slurry including the large-diameter particle group PL and the small-diameter particle group PS, which are mixed together, is applied to the partition base 6s, thereby forming the coating layer 8.

In the example shown in FIG. 7A, the coating layer 8 is provided on the surface of the partition base 6s, which faces the exhaust-gas inflow passage 5i, and is provided on a part of the inner surfaces of a partition pore 6p. In the example shown in FIG. 7B, the coating layer 8 is provided on the surface of the partition base 6s, which faces the exhaust-gas inflow passage 5i, and is provided on all of the inner surfaces of the partition pore 6p. In the example shown in FIG. 7C, the coating layer 8 is provided on all of the inner surfaces of the partition pore 6p, but is not provided on both surfaces of the partition base 6s, which face the exhaust-gas inflow passage 5i and the exhaust-gas outflow passage 5o, respectively. In the example shown in FIG. 7D, the coating layer 8 is provided on the surface of the partition base 6s, which faces the exhaust-gas inflow passage 5i, and is provided in the entirety of the inside space of the partition pore 6p.

The average particle diameter of the small-diameter particle group PS is approximately 0.1 to 10 μm for example. The average particle diameter of the large-diameter particle group PL is approximately half the average pore diameter of the partition base 6s, for example. In a case where the average pore diameter of the partition base 6s is 75 μm, the average particle diameter of the large-diameter particle group PL is equal to or smaller than 37.5 μm. The small-diameter particle group PS is formed from oxides, for example. The large-diameter particle group PL is formed from metal.

Particulate matter that is formed mainly from solid carbon is included in exhaust gas. This particulate matter is collected on the particulate filter 4.

Ash is also included in exhaust gas. The ash is collected along with the particulate matter by the particulate filter 4. The present inventors have confirmed that the ash is formed mainly from calcium salt, such as calcium sulfate (CaSO₄) or zinc calcium phosphate Ca₁₉Zn₂ (PO₄)₁₄. Calcium (Ca), zinc (Zn), phosphorus (P), and the like are derived from engine lubricant oil. Sulfur (S) is derived from fuel. That is, to take calcium sulfate (CaSO₄) as an example, the engine lubricant oil flows into a combustion chamber 2 and is burned, and calcium (Ca) in the lubricant oil bonds with sulfur (S) in the fuel, thereby producing calcium sulfate (CaSO₄).

According to the present inventors, it has been confirmed that, when a particulate filter that has the average pore diameter of approximately 10 to 25 μm and that does not include the coating layer 8, in other words, a particulate filter through which ash can hardly pass, is arranged within an engine exhaust passage, particulate matter tends to accumulate more on the upstream portion of the partition 6 than on the downstream portion of the partition 6. It has been further confirmed that, in this case, ash tends to accumulate more on the downstream portion of the partition 6 than on the upstream portion of the partition 6.

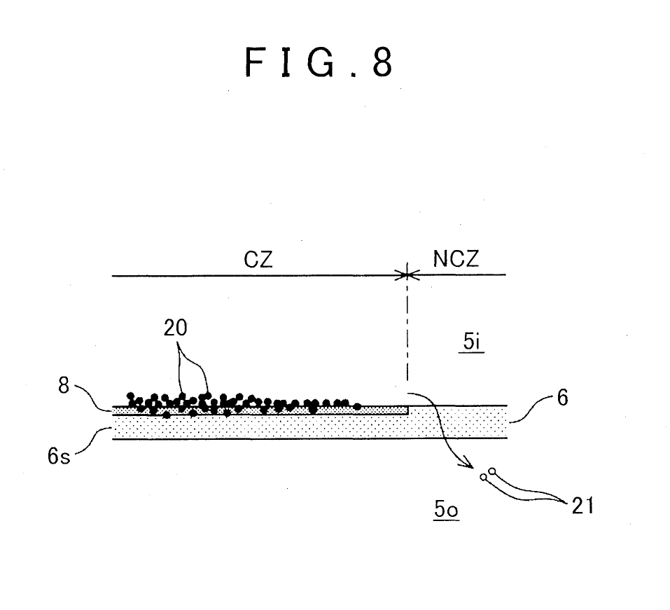

Thus, in the above embodiment, the coated zone CZ is provided on the upstream side of the partition 6, and the non-coated zone NCZ is provided on the downstream side of the partition 6. Consequently, as shown in FIG. 8, particulate matter 20 is collected by the partition 6 in the coated zone CZ on the upstream side, and ash 21 passes through the partition 6 in the non-coated zone NCZ on the downstream side. Therefore, ash can be prevented from accumulating on the particulate filter 4, while preventing particulate matter from passing through the particulate filter 4. In other words, an increase in pressure loss in the particulate filter 4 caused by ash can be suppressed, while collecting particulate matter.

In the internal combustion engine 1 shown in FIG. 1, each time the amount of particulate matter collected on the particulate filter 4 exceeds an upper limit amount, the PM removing process is performed to remove particulate matter from the particulate filter 4. For example, in the PM removing process, while a particulate filter is maintained in an oxidizing atmosphere, the temperature of the particulate filter is increased, and thus particulate matter is burnt.

In the above embodiment, the coating layer 8 is formed from the small-diameter particle group PS and the large-diameter particle group PL. With this configuration, the particulate matter 20 can be collected due to the following reasons.

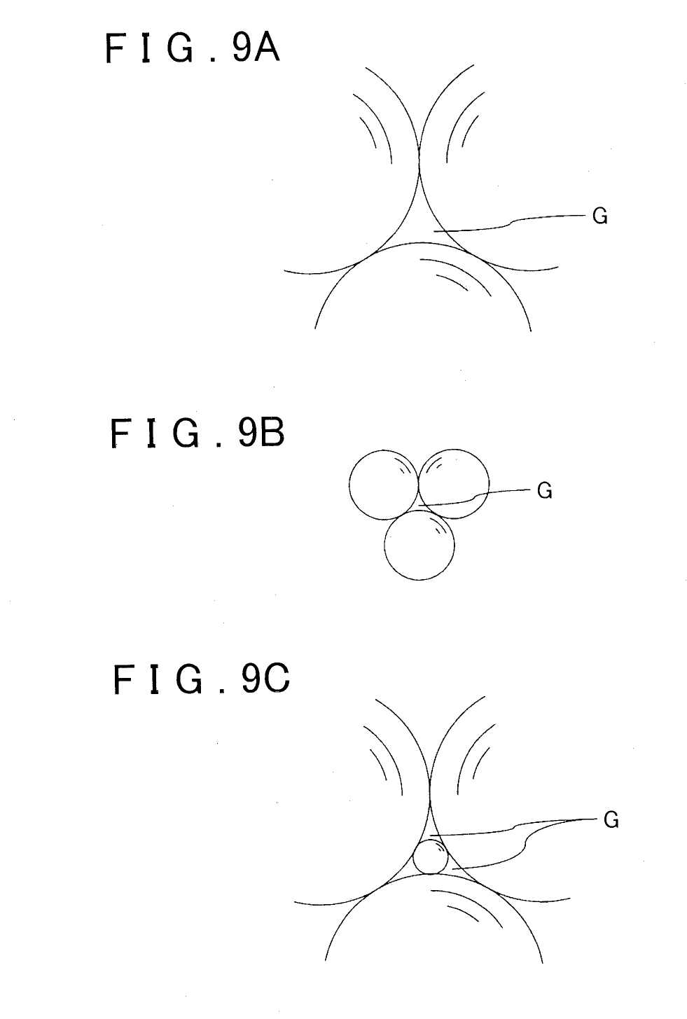

That is, when the coating layer 8 is formed from large-diameter particles, a gap or pore G formed between particles P is large as shown in FIG. 9A. In contrast to this, when the coating layer 8 is formed from small-diameter particles, the gap G between the particles P is small as shown in FIG. 9B. Further, when the coating layer 8 is formed from a combination of small-diameter particles and large-diameter particles, the gap G between the particles P is small as shown in FIG. 9C. In the embodiments shown in FIG. 6 and FIGS. 7A to 7D, a small gap between particles is formed as shown in FIG. 9B or 9C. As a result, small-diameter particulate matter can be collected, while releasing ash. Further, when the coating layer 8 is formed from particles having the oxidizing function, oxidation of particulate matter can be promoted.

It is also considered that when the coating layer 8 is formed only from small-diameter particles, collection of the particulate matter can be improved. However, in order for particulate matter to be collected by the coating layer 8, the opening of the pore 6p in the partition 6 needs to be covered with the coating layer 8. Meanwhile, in the embodiment of the present invention, the pore diameter of the partition 6 is set such that ash can pass through the partition 6. That is, the pore diameter of the partition 6 is relatively large. Thus, when the coating layer 8 is formed only from small-diameter particles, it may be difficult for the coating layer 8 to sufficiently cover the opening of the pore 6p in the partition 6.

In contrast to this, in the embodiments shown in FIG. 6 and FIGS. 7A to 7D, the large-diameter particle group PL is included in particles that form the coating layer 8. Therefore, the opening of the pore 6p in the partition 6 can be reliably covered with the coating layer 8. In this case, the small-diameter particle group PS can also be regarded as being held by the large-diameter particle group PL.

In the above embodiment, the coating layer 8 is formed from two particle groups with different average particle diameters from each other. In another embodiment, the coating layer 8 is formed from three or more particle groups with different average particle diameters from each other. Therefore, the coating layer 8 is formed from a plurality of particle groups with different average particle diameters from each other. In this case, a plurality of different peaks appears in the size distribution of particles that form the coating layer 8.

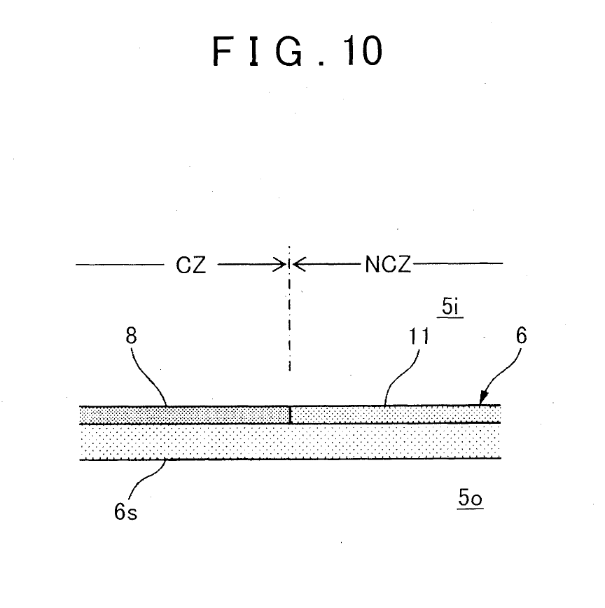

In the above embodiment, no coating layer is provided in the non-coated zone NCZ. In another embodiment shown in FIG. 10, an additional coating layer 11 that is different from the coating layer 8 is provided in the non-coated zone NCZ. In this case, the average pore diameter of the partition 6 in the non-coated zone NCZ with the additional coating layer 11 provided therein is set equal to or larger than 25 μm and equal to or smaller than 100 Metal having the oxidizing function is supported on the additional coating layer 11, for example. As a result, particulate matter having reached the non-coated zone NCZ can be easily oxidized and removed. A coating layer of low bulk density, such as a sol coating layer, is used as the additional coating layer 11.

While the present invention has been explained with reference to the embodiments, the present invention is not limited to the above embodiments and structure. The present invention may cover various modifications and equivalent configurations. More limited configurations of various constituent elements in the embodiments and various combinations of these configurations also fall within the scope of the present invention.

What is claimed is:

1. An exhaust gas purification filter that is arranged within an exhaust passage of an internal combustion engine, and that collects particulate matter included in exhaust gas, the exhaust gas purification filter comprising:
an inflow passage through which exhaust gas flows in;
an outflow passage through which exhaust gas flows out, the outflow passage and the inflow passage being alternately arranged; and
a partition configured to divide the inflow passage and the outflow passage from each other, and being porous, wherein
the partition including a coated zone where a surface of a base of the partition is covered with a first coating layer having an average pore diameter smaller than an average pore diameter of the base, and a non-coated zone where the surface of the base is not covered with the first coating layer on a downstream side of the coated zone, the average pore diameter of the base in the non-coated zone is large enough for ash included in exhaust gas to pass through the partition, and the first coating layer is constituted by a plurality of particle groups with different average particle diameters from each other.

2. The exhaust gas purification filter according to claim 1, wherein
the plurality of particle groups are arranged substantially into layers on the base, and an average particle diameter of the particle group that forms a layer closer to the base is larger than an average particle diameter of the particle group that forms a layer farther away from the base.

3. The exhaust gas purification filter according to claim 1, wherein the plurality of particle groups are arranged on the base in an almost evenly mixed state.

4. The exhaust gas purification filter according to claim 1, wherein the particle groups that form the first coating layer are made from metal having a catalytic function.

5. The exhaust gas purification filter according to claim 1, wherein a second coating layer that is different from the first coating layer is provided in the non-coated zone, and the second coating layer including a catalyst.

6. The exhaust gas purification filter according to claim 1, wherein
the inflow passage is opened at an exhaust-gas upstream end, and is closed at an exhaust-gas downstream end, and
the outflow passage is closed at the upstream end, and is opened at the downstream end.
